(19) United States
(12) Patent Application Publication
(10) Pub. No.: US 2024/0354092 A1
(43) Pub. Date: Oct. 24, 2024

(54) UPDATE APPARATUS OF SOFTWARE, UPDATE METHOD OF SOFTWARE, NON-TRANSITORY STORAGE MEDIUM, AND UPDATE SYSTEM OF SOFTWARE

(71) Applicant: TOYOTA JIDOSHA KABUSHIKI KAISHA, Toyota-shi (JP)

(72) Inventor: Tomoki SHIBUTANI, Nisshin-shi (JP)

(73) Assignee: TOYOTA JIDOSHA KABUSHIKI KAISHA, Toyota-shi (JP)

(21) Appl. No.: 18/594,784

(22) Filed: Mar. 4, 2024

(30) Foreign Application Priority Data
Apr. 18, 2023 (JP) 2023-067960

(51) Int. Cl. G06F 8/65; B60W 50/04

(52) U.S. Cl. CPC G06F 8/65; B60W 50/04; B60W 2756/10

(57) ABSTRACT

An update apparatus of software includes one or more processors configured to execute: transmitting an activation signal for instructing activation of software to an information processing apparatus mounted on a vehicle; starting to wait for reception of a product number signal indicating a product number of the software transmitted from the information processing apparatus on a condition that the activation signal is transmitted; and performing, on a condition that the product number signal is received, a consistency check of the software based on the received product number signal.

### CROSS-REFERENCE TO RELATED APPLICATION

This application claims priority to Japanese Patent Application No. 2023-067960 filed on Apr. 18, 2023, incorporated herein by reference in its entirety.

### BACKGROUND

### 1. Technical Field

The present disclosure relates to an update apparatus of software, an update method of the software, a non-transitory storage medium, and an update system of the software.

### 2. Description of Related Art

An update system of software in a vehicle in Japanese Unexamined Patent Application Publication No. 2019-159399 includes an update apparatus and a plurality of information processing apparatuses. The update apparatus executes the update of the software of the plurality of information processing apparatuses. Specifically, the update apparatus downloads new software. The update apparatus installs new software in the information processing apparatuses. The update apparatus transmits activation signals for instructing the activation of the new software to the information processing apparatuses. Then, when a system of the vehicle is changed from the OFF state to the ON state, for example, the software installed in the information processing apparatuses is activated.

The update apparatus executes a consistency check in accordance with the update of the software of the information processing apparatuses. The update apparatus receives product number signals indicating the product number of the software from all of the information processing apparatuses in the execution of the consistency check. The update apparatus performs a consistency check on whether the product number of the software of each information processing apparatus is consistent on the basis of product numbers indicated by the product number signals. In this consistency check, the update apparatus determines whether the latest product numbers of the software of the information processing apparatuses satisfy a correspondence relationship defined by design with each other.

### SUMMARY

In an update system such as that in Japanese Unexamined Patent Application Publication No. 2019-159399, there are cases in which the supply of electric power to some information processing apparatuses out of the plurality of information processing apparatuses is instantaneously cut off, for example. When the instantaneous interruption of the electric power supply occurs for some information processing apparatuses, those some information processing apparatuses are changed from the ON state to the OFF state and then changed to the ON state again. The software of those information processing apparatuses may be accordingly activated. Therefore, it can be conceived that the update apparatus constantly waits for the reception of a product number signal and execute a consistency check at a predetermined period, for example, in an update system as that in Japanese Unexamined Patent Application Publication No. 2019-159399. However, such an update system is not preferable in terms of the processing load of the update apparatus being large due to the number of times that the consistency check is executed becoming excessively large or the waiting for the reception of the product number signal becoming excessively long.

An update apparatus of software according to a first aspect of the present disclosure executes: transmitting an activation signal for instructing activation of software to an information processing apparatus mounted on a vehicle; starting to wait for reception of a product number signal indicating a product number of the software transmitted from the information processing apparatus on the condition that the activation signal is transmitted; and performing, on the condition that the product number signal is received, a consistency check of the software based on the received product number signal.

An update method of software according to a second aspect of the present disclosure includes executing: transmitting an activation signal for instructing activation of software to an information processing apparatus mounted on a vehicle; starting to wait for reception of a product number signal indicating a product number of the software transmitted from the information processing apparatus on the condition that the activation signal is transmitted; and performing, on the condition that the product number signal is received, a consistency check of the software based on the received product number signal.

A non-transitory storage medium according to a third aspect of the present disclosure stores instructions that are executable by one or more processors of an update apparatus and that cause the one or more processors to perform the update method of software according to the second aspect.

An update system of software according to a fourth aspect of the present disclosure includes: an update apparatus mounted on a vehicle; and an information processing apparatus mounted on the vehicle. The update apparatus is configured to execute: transmitting an activation signal for instructing activation of software to an information processing apparatus; and starting to wait for reception of a product number signal indicating a product number of the software transmitted from the information processing apparatus on the condition that the activation signal is transmitted. The information processing apparatus is configured to execute: performing the activation of the software at a timing where a state of the information processing apparatus changes from the OFF state to the ON state on the condition that the activation signal is received; and transmitting the product number signal to the update apparatus on the condition that the activation is performed. The update apparatus executes performing, on the condition that the product number signal is received, a consistency check of the software based on the received product number signal.

According to the configuration, for example, it becomes possible to reduce the processing load of the update apparatus as compared to a case in which the update apparatus constantly waits for the reception of the product number signal and executes the consistency check at a predetermined period.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an update system according to a first embodiment;

FIG. 2 is a flowchart showing a consistency check control according to the first embodiment;

FIG. 3 is a flowchart showing a first control according to the first embodiment;

FIG. 4 is a flowchart showing a second control according to the first embodiment;

FIG. 5 is a flowchart showing a consistency check control according to a second embodiment; and

FIG. 6 is a flowchart showing a third control according to the second embodiment.

### DETAILED DESCRIPTION OF EMBODIMENTS

### First Embodiment

### Schematic Configuration of Update System

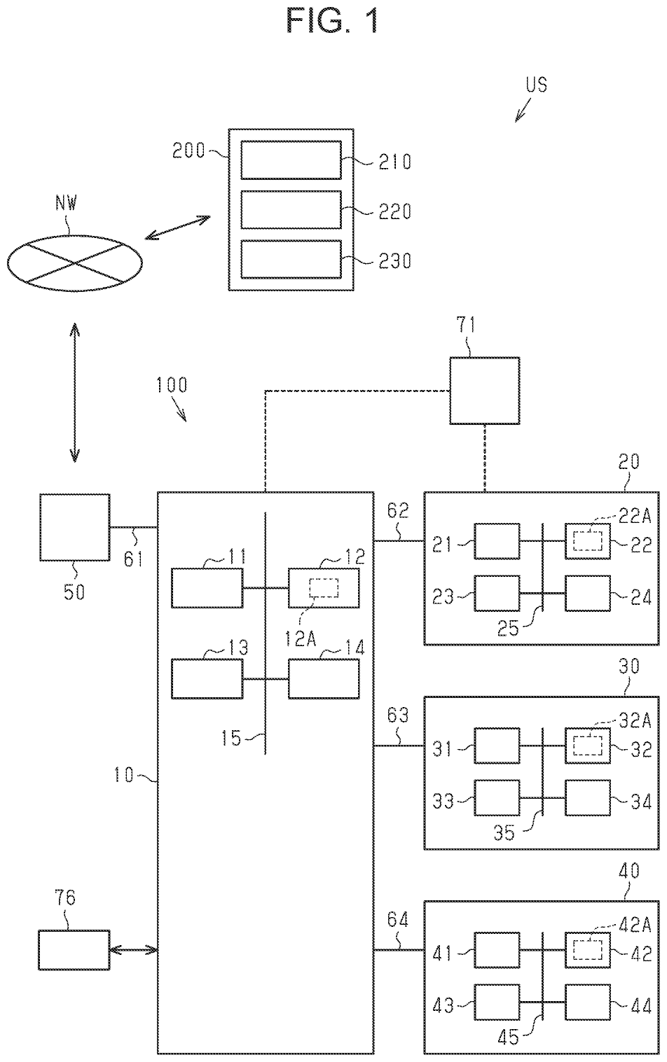

A first embodiment of the present disclosure is described below with reference to FIG. 1 to FIG. 4. A schematic configuration of an update system US is described first.

As shown in FIG. 1, the update system US includes a plurality of vehicles 100. The vehicle 100 is an automobile owned by a user, for example. In FIG. 1, only one vehicle 100 is representatively shown.

The vehicle 100 includes a central ECU 10, a power train ECU 20, a brake ECU 30, an advanced driving assistance ECU 40, and a DCM 50. The vehicle 100 includes a first external bus 61, a second external bus 62, a third external bus 63, and a fourth external bus 64. The “ECU” is an abbreviation for an electronic control unit. The “DCM” is an abbreviation for a data communication module. In the present embodiment, the central ECU 10 is one example of an update apparatus of software. Each of the power train ECU 20, the brake ECU 30, and the advanced driving assistance ECU 40 is one example of the information processing apparatus in which the update of the software is performed.

The central ECU 10 integrally controls the entire vehicle 100. The central ECU 10 includes a CPU 11, a ROM 12, a RAM 13, a storage 14, and an internal bus 15. The internal bus 15 communicably connects the CPU 11, the ROM 12, the RAM 13, and the storage 14 to each other. The ROM 12 stores various programs and various data therein in advance. The ROM 12 stores an update program 12A executed when the software is updated therein in advance as one of the various programs. The RAM 13 is a volatile memory. The RAM 13 temporarily stores therein various programs and various data. The CPU 11 executes various processing by reading out the program in the ROM 12 by using the RAM 13 as a working area. The CPU 11 executes various processing in an update method of the software by reading out the update program 12A.

The storage 14 can store therein various programs and various data. The storage 14 is a non-volatile memory that can be electrically rewritten. For example, the storage 14 is a NAND flash memory.

The DCM 50 is connected to the central ECU 10 via the first external bus 61. The DCM 50 can wirelessly communicate with external devices of the vehicle 100 via a communication network NW. Therefore, the central ECU 10 can wirelessly communicate with the external devices of the vehicle 100 via the first external bus 61 and the DCM 50.

The power train ECU 20 can communicate with the central ECU 10 via the second external bus 62. The power train ECU 20 executes various processing for controlling an engine, a transmission, and the like (not shown). The power train ECU 20 includes a CPU 21, a ROM 22, a RAM 23, a storage 24, and an internal bus 25. The internal bus 25 communicably connects the CPU 21, the ROM 22, the RAM 23, and the storage 24 to each other. The ROM 22 stores various programs and various data therein in advance. The ROM 22 stores a control program 22A therein in advance as one of the various programs. The ROM 22 is a so-called erasable programmable read only memory (EPROM). In other words, the control program 22A stored in the ROM 22 is updatable. The ROM 22 is a so-called two-sided ROM having two storage areas of data. In other words, in the ROM 22, even when the ROM 22 is in the ON state, software can be installed into another storage area other than the storage area of the data used in the ON state. The RAM 23 is a volatile memory. The RAM 23 temporarily stores therein various programs and various data. The CPU 21 executes various processing by reading out the program in the ROM 22 by using the RAM 23 as a working area. The CPU 21 executes various processing for controlling the engine, the transmission, and the like by reading out the control program 22A.

The storage 24 can store therein various programs and various data. The storage 24 is a non-volatile memory that can be electrically rewritten. For example, the storage 24 is a NOR flash memory.

The brake ECU 30 can communicate with the central ECU 10 via the third external bus 63. The brake ECU 30 controls a brake apparatus (not shown). The internal configuration of the brake ECU 30 is similar to the internal configuration of the power train ECU 20. In other words, the brake ECU 30 includes a CPU 31, a ROM 32, a RAM 33, a storage 34, and an internal bus 35. The ROM 32 stores a control program 32A therein in advance as one of the various programs. The CPU 31 executes various processing for controlling the brake apparatus by reading out the control program 32A.

The advanced driving assistance ECU 40 can communicate with the central ECU 10 via the fourth external bus 64. The advanced driving assistance ECU 40 realizes various driving assistances by executing various application software. The various application software includes software for traveling by following a leading vehicle that travels ahead of the vehicle 100 while maintaining a fixed inter-vehicular distance with the leading vehicle, software for autonomously applying brakes to reduce damage due to collision with respect to the vehicle 100, and the like. The internal configuration of the advanced driving assistance ECU 40 is similar to the internal configuration of the power train ECU 20. In other words, the advanced driving assistance ECU 40 includes a CPU 41, a ROM 42, a RAM 43, a storage 44, and an internal bus 45. The ROM 42 stores a control program 42A therein in advance as one of the various programs. The CPU 41 executes various processing for realizing the various driving assistances described above by reading out the control program 42A.

As shown in FIG. 1, the vehicle 100 includes a device group configured by a plurality of devices. Examples of those devices are a secondary battery 71 and a display 76. The secondary battery 71 supplies electric power to the central ECU 10, the power train ECU 20, the brake ECU 30, the advanced driving assistance ECU 40, the DCM 50, and the like. In FIG. 1, only an electric power path that connects the secondary battery 71 and the central ECU 10 to each other and an electric power path that connects the secondary battery 71 and the power train ECU 20 to each other are representatively shown.

The display 76 can display various information. The display 76 is a so-called touch screen display. Therefore, the user of the vehicle 100 can input various information via the display 76. In other words, the display 76 functions as an output device that outputs information to the user and an input device that accepts information from the user.

The central ECU 10 displays various information in the display 76 by outputting a control signal to the display 76. The central ECU 10 acquires the information input by the user of the vehicle 100 from the display 76.

As shown in FIG. 1, the update system US includes a data center 200. One example of the data center 200 is a so-called server. The data center 200 includes an execution unit 210, a storage unit 220, and a communication unit 230. The communication unit 230 can communicate with a device outside of the data center 200 via the communication network NW. The storage unit 220 includes a ROM, a RAM, and a storage. The storage unit 220 stores various data therein. The storage unit 220 stores therein various programs in advance. The execution unit 210 executes various processing by reading the programs of the storage unit 220. One example of the execution unit 210 is a CPU.

### Consistency Check Control

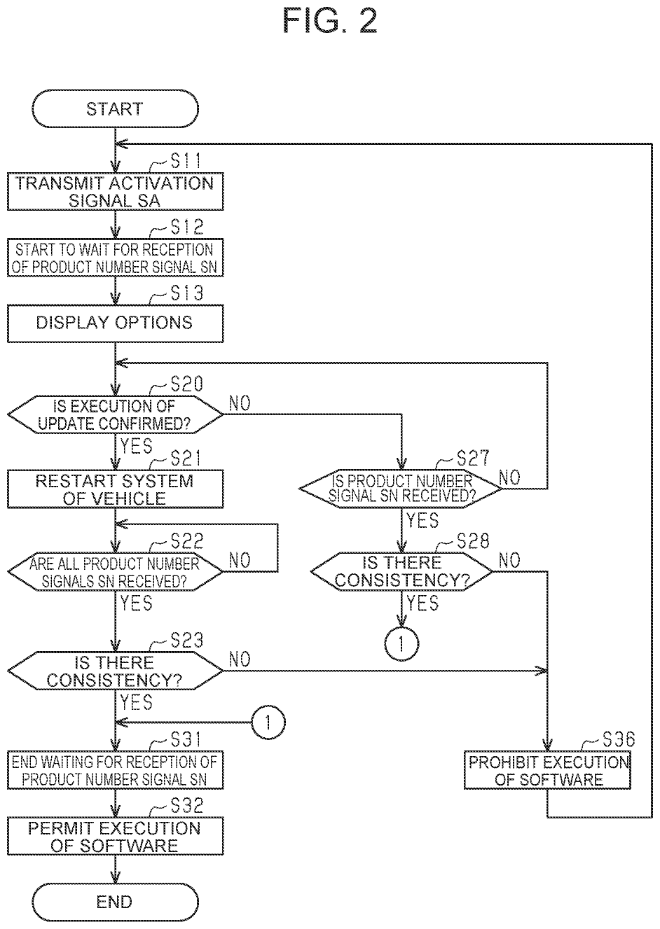

Next, with reference to FIG. 2, a consistency check control executed by the central ECU 10 is described. In the present embodiment, the CPU 11 of the central ECU 10 executes the consistency check control when all of Requirement (1) to Requirement (3) below are satisfied, for example.

Requirement (1): The central ECU 10 receives a campaign notification indicating that there is new software from the data center 200.

Requirement (2): The new software to be updated is stored in the storage 14 of the central ECU 10 as a result of the new software being downloaded from the data center 200 after the reception of the campaign notification.

Requirement (3): The new software is installed to the information processing apparatus to be updated after the download of the new software.

As one example of the update of the software, processing when the control program 22A, the control program 32A, and the control program 42A are updated is described below. Therefore, in the example described here, Requirement (3) is satisfied when the control program 22A is installed in the ROM 22, the control program 32A is installed in the ROM 32, and the control program 42A is installed in the ROM 42. In the present embodiment, the CPU 11 of the central ECU 10 acquires a consistency table TM with the new software when the new software is downloaded. The consistency table TM includes information indicating the version of the new software. Details of the consistency table TM are described below.

As shown in FIG. 2, the CPU 11 of the central ECU 10 executes processing of Step S11 when the consistency check control is started. In Step S11, the CPU 11 of the central ECU 10 transmits an activation signal SA for instructing the activation of the new software to each of the power train ECU 20, the brake ECU 30, and the advanced driving assistance ECU 40. After Step S11, the CPU 11 of the central ECU 10 causes the processing to proceed to Step S12. In other words, the CPU 11 of the central ECU 10 causes the processing to proceed to Step S12 on the condition that the activation signals SA are transmitted.

In Step S12, the CPU 11 of the central ECU 10 starts to wait for the reception of a product number signal SN transmitted from each of the power train ECU 20, the brake ECU 30, and the advanced driving assistance ECU 40. In the present embodiment, the product number signal SN indicates the version of the software of the information processing apparatus. The version of the software of the information processing apparatus is one example of a product number of the software of the information processing apparatus. In this first embodiment, the product number signal SN is transmitted from each of the power train ECU 20, the brake ECU 30, and the advanced driving assistance ECU 40 when a second control described later is executed. After Step S12, the CPU 11 of the central ECU 10 causes the processing to proceed to Step S13.

In Step S13, the CPU 11 of the central ECU 10 confirms whether the user of the vehicle 100 agrees to the performance of the update of the software. Specifically, the CPU 11 of the central ECU 10 displays options regarding whether to agree to the performance of the update of the software on the display 76 by outputting a control signal to the display 76. The CPU 11 of the central ECU 10 displays reminder information indicating that a system of the vehicle 100 is restarted in accordance with the update of the software on display 76. After Step S13, the CPU 11 of the central ECU 10 causes the processing to proceed to Step S20.

In Step S20, the CPU 11 of the central ECU 10 determines whether the agreement to the performance of the update of the software has been able to be confirmed. For example, when the user of the vehicle 100 agrees to the performance of the update of the software by operating the display 76, the CPU 11 of the central ECU 10 determines that the agreement to the performance of the update of the software has been able to be confirmed. When the CPU 11 of the central ECU 10 determines that the agreement to the performance of the update of the software has been able to be confirmed in Step S20 (S20: YES), the CPU 11 of the central ECU 10 causes the processing to proceed to Step S21.

In Step S21, the CPU 11 of the central ECU 10 restarts the system of the vehicle 100. Specifically, the CPU 11 of the central ECU 10 changes the system of the vehicle 100 to the OFF state. Then, the CPU 11 of the central ECU 10 places the system of the vehicle 100 in the ON state. Here, the expression of “the system of the vehicle 100 is in the OFF state” means a state in which electric power is not supplied to each ECU except for the central ECU 10 and the vehicle 100 cannot travel as a result. The expression of “the system of the vehicle 100 is in the ON state” means a state in which electric power is supplied to all of the ECUs including the central ECU 10. Therefore, the expression of “the system of the vehicle 100 is in the ON state” includes a so-called accessory ON state. After Step S21, the CPU 11 of the central ECU 10 causes the processing to proceed to Step S22. In other words, the CPU 11 of the central ECU 10 causes the processing to proceed to Step S22 when the system of the vehicle 100 is changed from the OFF state to the ON state while the reception of the product number signal SN is waited for.

In Step S22, the CPU 11 of the central ECU 10 determines whether the product number signals SN have been received from all of the information processing apparatuses. Specifically, when the CPU 11 of the central ECU 10 receives a total of three product number signals SN from the power train ECU 20, the brake ECU 30, and the advanced driving assistance ECU 40, the CPU 11 of the central ECU 10 determines that the product number signals SN have been received from all of the information processing apparatuses. When the CPU 11 of the central ECU 10 receives the product number signal SN, the CPU 11 of the central ECU 10 stores the product number signal SN in the storage 14 by linking the product number signal SN to the information processing apparatus that transmitted the product number signal SN. When the CPU 11 of the central ECU 10 determines that the product number signals SN are not received from all of the information processing apparatuses in Step S22 (S22: NO), the CPU 11 of the central ECU 10 causes the processing to proceed to Step S22 again. Meanwhile, when the CPU 11 of the central ECU 10 determines that the product number signals SN are received from all of the information processing apparatuses in Step S22 (S22: YES), the CPU 11 of the central ECU 10 causes the processing to proceed to Step S23.

In Step S23, the CPU 11 of the central ECU 10 determines whether the software of the information processing apparatuses is consistent. Specifically, the CPU 11 of the central ECU 10 performs the consistency check of the software of the information processing apparatuses on the basis of the consistency table TM and the received product number signals SN. Here, the received product number signals SN are the product number signals SN received in Step S22 immediately before. In the consistency table TM, combinations allowable as combinations of the versions of the software of each information processing apparatus are defined in advance. The CPU 11 of the central ECU 10 performs the consistency check by comparing the combination of the versions of the software indicated by the three received product number signals SN with the consistency table TM. Then, the CPU 11 determines that the software of each information processing apparatus is consistent when the combination of the versions of the software indicated by the three product number signals SN coincides with the combination of the versions of the software defined in the consistency table TM. Meanwhile, the CPU 11 determines that the software of each information processing apparatus is not consistent when the combination of the versions of the software indicated by the three product number signals SN does not coincide with the combination of the versions of the software defined in the consistency table TM.

When the CPU 11 of the central ECU 10 determines that the software of the information processing apparatuses is consistent in Step S23 (S23: YES), the CPU 11 of the central ECU 10 causes the processing to proceed to Step S31. In other words, when the CPU 11 of the central ECU 10 determines that the software of the information processing apparatuses is consistent by the consistency check in Step S23, the CPU 11 of the central ECU 10 causes the processing to proceed to Step S31.

In Step S31, the CPU 11 of the central ECU 10 ends the waiting for the reception of the product number signal SN transmitted from each of the power train ECU 20, the brake ECU 30, and the advanced driving assistance ECU 40. After Step S31, the CPU 11 of the central ECU 10 causes the processing to proceed to Step S32.

In Step S32, the CPU 11 of the central ECU 10 permits the execution of the software to be updated. Specifically, the CPU 11 of the central ECU 10 permits the execution of the control program 22A of the power train ECU 20, the control program 32A of the brake ECU 30, and the control program 42A of the advanced driving assistance ECU 40. As a result, various controls that can be realized by executing the control program 22A, the control program 32A, and the control program 42A, for example, a control such as the autonomous driving of the vehicle 100 are permitted. After Step S32, the CPU 11 of the central ECU 10 ends the current consistency check control.

Meanwhile, when the CPU 11 of the central ECU 10 determines that the software of the information processing apparatuses is not consistent in Step S23 (S23: NO), the CPU 11 of the central ECU 10 causes the processing to proceed to Step S36.

In Step S36, the CPU 11 of the central ECU 10 prohibits the execution of the software to be updated. Specifically, the CPU 11 of the central ECU 10 prohibits the execution of the control program 22A of the power train ECU 20, the control program 32A of the brake ECU 30, and the control program 42A of the advanced driving assistance ECU 40. As a result, various controls that can be realized by executing the control program 22A, the control program 32A, and the control program 42A, for example, a control such as the autonomous driving of the vehicle 100 are prohibited. After Step S36, the CPU 11 of the central ECU 10 causes the processing to proceed to Step S11 again.

When the CPU 11 of the central ECU 10 determines that the agreement to the performance of the update of the software cannot be confirmed in Step S20 (S20: NO), the CPU 11 of the central ECU 10 causes the processing to proceed to Step S27. In other words, the CPU 11 of the central ECU 10 causes the processing to proceed to Step S27 before the system of the vehicle 100 is changed from the OFF state to the ON state while the reception of the product number signal SN is waited for.

In Step S27, the CPU 11 of the central ECU 10 determines whether the product number signal SN has been received from the information processing apparatuses. Specifically, when the CPU 11 of the central ECU 10 receives one or more product number signals SN from the power train ECU 20, the brake ECU 30, and the advanced driving assistance ECU 40, the CPU 11 of the central ECU 10 determines that the product number signal SN has been received from the information processing apparatuses. When the CPU 11 of the central ECU 10 receives the product number signal SN, the CPU 11 of the central ECU 10 stores the product number signal SN in the storage 14 by linking the product number signal SN to the information processing apparatus that transmitted the product number signal SN. When the CPU 11 of the central ECU 10 determines that the product number signal SN is not received from the information processing apparatuses in Step S27 (S27: NO), the CPU 11 of the central ECU 10 causes the processing to proceed to Step S20 again. Meanwhile, when the CPU 11 of the central ECU 10 determines that the product number signal SN has been received from the information processing apparatuses in Step S27 (S27: YES), the CPU 11 of the central ECU 10 causes the processing to proceed to Step S28.

In Step S28, the CPU 11 of the central ECU 10 determines whether the software of the information processing apparatuses is consistent. Specifically, the CPU 11 of the central ECU 10 performs the consistency check of the software of the information processing apparatuses on the basis of the consistency table TM, the received product number signal SN, and the product number signals SN stored in the storage 14. Here, the received product number signal SN is the product number signal SN received in Step S27 immediately before. The product number signals SN stored in the storage 14 are the product number signals SN received in Step S22 of the past or Step S27 of the past. For example, the CPU 11 of the central ECU 10 receives the product number signal SN from only the power train ECU 20 in Step S27. In this case, the CPU 11 sets the product number signal SN received at a time point closest to the time point of the processing of Step S28 out of the product number signals SN from the brake ECU 30 stored in the storage 14 to be the product number signal SN from the brake ECU 30 to be used in Step S28. Similarly, the CPU 11 sets the product number signal SN received at a time point closest to the time point of the processing of Step S28 out of the product number signals SN from the advanced driving assistance ECU 40 stored in the storage 14 to be the product number signal SN from the advanced driving assistance ECU 40 to be used in Step S28. Then, the CPU 11 of the central ECU 10 performs the consistency check by comparing the combination of the versions of the software indicated by the received product number signal SN and the product number signals SN stored in the storage 14 with the consistency table TM. Specifically, as with the processing in Step S23, the CPU 11 determines that the software of each information processing apparatus is consistent when the combination of the versions of the software indicated by three product number signals SN coincides with the combination of the versions of the software defined in the consistency table TM. Meanwhile, the CPU 11 determines that the software of each information processing apparatus is not consistent when the combination of the versions of the software indicated by the three product number signals SN does not coincide with the combination of the versions of the software defined in the consistency table TM.

When the CPU 11 of the central ECU 10 determines that the software of the information processing apparatuses is consistent in Step S28 (S28: YES), the CPU 11 of the central ECU 10 causes the processing to proceed to Step S31. In other words, when the CPU 11 of the central ECU 10 determines that the software of the information processing apparatuses is consistent by the consistency check in Step S28, the CPU 11 of the central ECU 10 causes the processing to proceed to Step S31 and Step S32 thereafter. The processing of Step S31 and Step S32 is as described above.

Meanwhile, when the CPU 11 of the central ECU 10 determines that the software of the information processing apparatuses is not consistent in Step S28 (S28: NO), the CPU 11 of the central ECU 10 causes the processing to proceed to Step S36. The processing of Step S36 is as described above.

### First Control

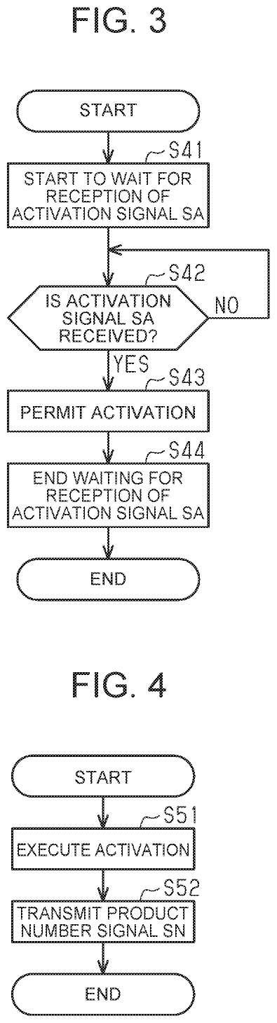

Next, with reference to FIG. 3, a first control executed by each of the power train ECU 20, the brake ECU 30, and the advanced driving assistance ECU 40 is described. The first control is a control relating to the permission of the activation of the software based on the activation signal SA. The first control executed by the power train ECU 20 is described below. The CPU 21 of the power train ECU 20 executes the first control when all of Requirement (1) to Requirement (3) are satisfied, for example.

As shown in FIG. 3, the CPU 21 of the power train ECU 20 executes processing of Step S41 when the first control starts. In Step S41, the CPU 21 of the power train ECU 20 starts to wait for the reception of the activation signal SA transmitted from the central ECU 10. After Step S41, the CPU 21 of the power train ECU 20 causes the processing to proceed to Step S42.

In Step S42, the CPU 21 of the power train ECU 20 determines whether the activation signal SA has been received. When the CPU 21 of the power train ECU 20 determines that the activation signal SA is not received in Step S42 (S42: NO), the CPU 21 of the power train ECU 20 causes the processing to proceed to Step S42 again. Meanwhile, when the CPU 21 of the power train ECU 20 determines that the activation signal SA is received in Step S42 (S42: YES), the CPU 21 of the power train ECU 20 causes the processing to proceed to Step S43.

In Step S43, the CPU 21 of the power train ECU 20 permits the activation of the new software. As a result, it becomes possible to activate the software in a second control described later. In other words, at the time point of the processing of Step S43, only the activation of the software is permitted, and the activation of the software itself is not executed. After Step S43, the CPU 21 of the power train ECU 20 causes the processing to proceed to Step S44.

In Step S44, the CPU 21 of the power train ECU 20 ends the waiting for the reception of the activation signal SA transmitted from the central ECU 10. After Step S44, the CPU 21 of the power train ECU 20 ends the current first control.

### Second Control

Next, with reference to FIG. 4, the second control executed by each of the power train ECU 20, the brake ECU 30, and the advanced driving assistance ECU 40 is described. This second control is a control relating to the execution of the activation of the software. The second control executed by the power train ECU 20 is described below. The CPU 21 of the power train ECU 20 executes the second control when Requirement (4) and Requirement (5) below are satisfied, for example.

Requirement (4): The first control is executed.

Requirement (5): The information processing apparatus is changed from the OFF state to the ON state.

For example, when the system of the vehicle 100 is restarted, the state of the system of the vehicle 100 changes in the order of the ON state, the OFF state, and the ON state, and hence the state of the power train ECU 20 changes in the order of the ON state, the OFF state, and the ON state. As a result, Requirement (5) is satisfied when the power train ECU 20 changes from the OFF state to the ON state. For example, the state of the power train ECU 20 changes in the order of the state of the ON state, the OFF state, and the ON state as a result of occurrence of so-called instantaneous interruption of the electric power supply in which the supply of the electric power from the secondary battery 71 to the power train ECU 20 is instantaneously interrupted. Requirement (5) is satisfied when the power train ECU 20 changes from the OFF state to the ON state as a result.

As shown in FIG. 4, the CPU 21 of the power train ECU 20 executes processing of Step S51 when the second control starts. In Step S51, the CPU 21 of the power train ECU 20 executes the activation of the new software. After Step S51, the CPU 21 of the power train ECU 20 causes the processing to proceed to Step S52.

In Step S52, the CPU 21 of the power train ECU 20 transmits the product number signal SN to the central ECU 10. After Step S52, the CPU 21 of the power train ECU 20 ends the current second control.

### Effects of Present Embodiment

For example, in the vehicle 100, the control program 22A is installed in the ROM 22, the control program 32A is installed in the ROM 32, and the control program 42A is installed in the ROM 42. In this case, as shown in FIG. 2, the CPU 11 of the central ECU 10 executes the consistency check control. The CPU 11 of the central ECU 10 causes the processing to proceed to Step S12 on the condition that the activation signal SA is transmitted in Step S11. In Step S12, the CPU 11 of the central ECU 10 starts waiting for the reception of the product number signal SN transmitted from each of the power train ECU 20, the brake ECU 30, and the advanced driving assistance ECU 40. The CPU 11 of the central ECU 10 restarts the system of the vehicle 100 in Step S21 when the agreement to the performance of the update of the software has been able to be confirmed in Step S20. The CPU 11 of the central ECU 10 causes the processing to proceed to Step S22 when the system of the vehicle 100 is changed from the OFF state to the ON state while the reception of the product number signals SN is waited for. Then, the CPU 11 of the central ECU 10 performs the consistency check of the software of the information processing apparatuses in Step S23 on the condition that the product number signals SN are received from all of the information processing apparatuses in Step S22. Specifically, the CPU 11 of the central ECU 10 performs a consistency check of the software of the information processing apparatuses on the basis of the consistency table TM and the received product number signals SN.

Meanwhile, the CPU 11 of the central ECU 10 causes the processing to proceed to Step S27 before the system of the vehicle 100 is changed from the OFF state to the ON state while the reception of the product number signals SN is waited for. Then, in Step S27, the CPU 11 of the central ECU 10 performs the consistency check of the software of the information processing apparatuses in Step S28 on the condition that the product number signal SN is received from one or more information processing apparatuses. Specifically, the CPU 11 of the central ECU 10 performs the consistency check of the software of the information processing apparatuses on the basis of the consistency table TM, the received product number signals SN, and the product number signals SN stored in the storage 14.

### Effects of Present Embodiment

(1-1) In the vehicle 100, before the system of the vehicle 100 changes from the OFF state to the ON state, the software of some information processing apparatuses may be activated due to some reason, for example, the occurrence of an instantaneous interruption of the electric power supply. Meanwhile, the CPU 11 of the central ECU 10 starts to wait for the reception of the product number signal SN in Step S12 on the condition that the activation signal SA is transmitted in Step S11. In other words, the CPU 11 of the central ECU 10 starts to wait for the reception of the product number signal SN in Step S12 in a situation in which the product number signal SN may be transmitted from the power train ECU 20 and the like. Then, the CPU 11 of the central ECU 10 performs the consistency check of the software of the information processing apparatuses on the basis of the received product number signal SN in Step S23 or Step S28 on the condition that the product number signal SN is received. As a result, it becomes possible to reduce the processing load of the CPU 11 of the central ECU 10 as compared to a case in which the CPU 11 of the central ECU 10 constantly waits for the reception of the product number signal SN and executes the consistency check at a predetermined period, for example.

(1-2) The CPU 11 of the central ECU 10 performs the consistency check of the software on the condition that the product number signal SN is received from each of all of the information processing apparatuses when the system of the vehicle 100 changes from the OFF state to the ON state while the reception of the product number signal SN is waited for. Specifically, the CPU 11 of the central ECU 10 performs the consistency check of the software of the information processing apparatuses on the basis of the consistency table TM and the received product number signals SN. As a result, it becomes possible to correctly execute the consistency check of the software of each information processing apparatus in a situation in which the product number signals SN are received from all of the information processing apparatuses in Step S22.

Meanwhile, the CPU 11 of the central ECU 10 performs the consistency check of the software on the condition that the product number signal SN is received from one or more information processing apparatuses before the system of the vehicle 100 changes from the OFF state to the ON state while the reception of the product number signal SN is waited for. Specifically, the CPU 11 of the central ECU 10 performs the consistency check of the software of the information processing apparatuses on the basis of the consistency table TM, the received product number signal SN, and the product number signals SN stored in the storage 14. Therefore, the CPU 11 of the central ECU 10 uses the product number signals SN stored in the storage 14, in other words, the product number signals SN received in the past for the information processing apparatus from which the product number signal SN has not been able to be received in Step S27. As a result, it becomes possible to correctly execute the consistency check of the software of each information processing apparatus even in a situation in which the product number signals SN are only received from some of the information processing apparatuses in Step S27.

(1-3) For example, the necessity of receiving the product number signal SN is low in a situation in which the product number signals SN have been received from all of the information processing apparatuses or it has been determined that the software of the information processing apparatuses is consistent by the consistency check. Regarding this point, the CPU 11 of the central ECU 10 ends the waiting for the reception of the product number signal SN in Step S31 when it has determined that the software of the information processing apparatuses is consistent by the consistency check in Step S23 or Step S28. As a result, it becomes possible to reduce the period of time that the waiting for the reception of the product number signal SN is executed as compared to a case in which the waiting for the reception of the product number signal SN is continued, for example.

### Second Embodiment

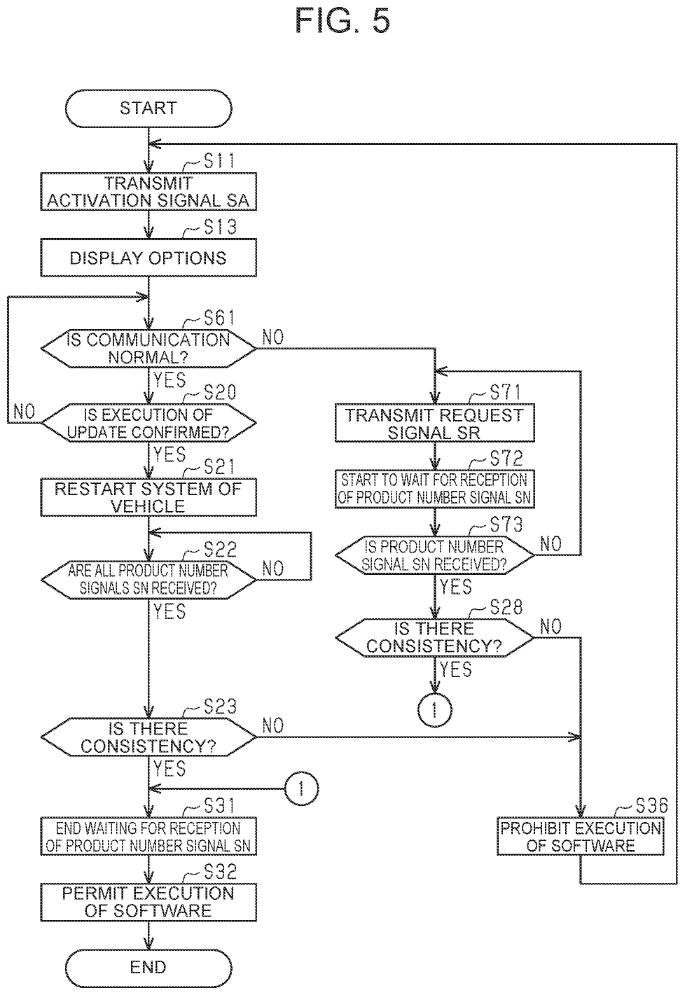

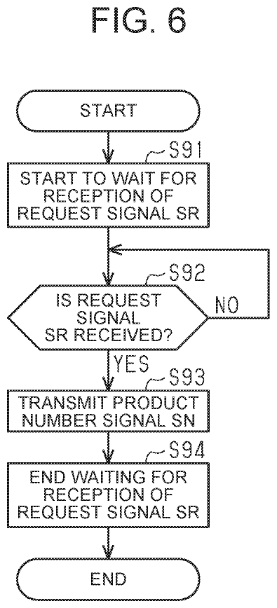

A second embodiment of the present disclosure is described below with reference to FIG. 5 and FIG. 6. In the second embodiment, some processing of the consistency check control is different from that of the first embodiment. The second embodiment is different from the first embodiment in that a third control described later is executed in addition to the first control and the second control. In the description of the second embodiment, the differences from the first embodiment are mainly described, configurations similar to those of the first embodiment are denoted by the same reference characters, and the description is omitted or simplified.

### Consistency Check Control

First, with reference to FIG. 5, a consistency check control executed by the central ECU 10 is described.

As shown in FIG. 5, the CPU 11 of the central ECU 10 executes processing of Step S11 when the consistency check control is started. In Step S11, the CPU 11 of the central ECU 10 transmits the activation signal SA for instructing the activation of the new software to each of the power train ECU 20, the brake ECU 30, and the advanced driving assistance ECU 40. After Step S11, the CPU 11 of the central ECU 10 causes the processing to proceed to Step S13.

In Step S13, the CPU 11 of the central ECU 10 confirms whether the user of the vehicle 100 agrees to the performance of the update of the software. After Step S13, the CPU 11 of the central ECU 10 causes the processing to proceed to Step S61.

In Step S61, the CPU 11 of the central ECU 10 determines whether the communication state of the power train ECU 20, the brake ECU 30, and the advanced driving assistance ECU 40 is normal. The CPU 11 of the central ECU 10 determines whether the communication state is normal as below, for example. In general, each of the power train ECU 20, the brake ECU 30, and the advanced driving assistance ECU 40 transmits a regular signal to the central ECU 10 for every fixed period of time set in advance. Therefore, the CPU 11 of the central ECU 10 determines that the communication state is normal when a total of three regular signals are received from the power train ECU 20 and the like within a fixed period of time preceding the time point of the processing of Step S61. Meanwhile, the CPU 11 of the central ECU 10 determines that the communication state is not normal when one or more regular signals out of the power train ECU 20 and the like have not been able to be received within the fixed period of time preceding the time point of the processing of Step S61. When the CPU 11 of the central ECU 10 determines that the communication state is normal in Step S61 (S61: YES), the CPU 11 of the central ECU 10 causes the processing to proceed to Step S20.

In Step S20, the CPU 11 of the central ECU 10 determines whether the agreement to the performance of the update of the software has been able to be confirmed. When the CPU 11 of the central ECU 10 determines that the agreement to the performance of the update of the software cannot be confirmed in Step S20 (S20: NO), the CPU 11 of the central ECU 10 causes the processing to proceed to Step S61 again. Meanwhile, when the CPU 11 of the central ECU 10 determines that the agreement to the performance of the update of the software has been able to be confirmed in Step S20 (S20: YES), the CPU 11 of the central ECU 10 causes the processing to proceed to Step S21. The processing in Step S21 and thereafter in the second embodiment is similar to the processing in Step S21 and thereafter in the first embodiment.

Meanwhile, when the CPU 11 of the central ECU 10 determines that the communication state is not normal in Step S61 (S61: NO), the CPU 11 of the central ECU 10 causes the processing to proceed to Step S71. In other words, the CPU 11 of the central ECU 10 causes the processing to proceed to Step S71 on the condition that the communication with the information processing apparatuses is interrupted.

In Step S71, the CPU 11 of the central ECU 10 transmits request signals SR for requesting the transmission of the product number signals SN to the information processing apparatuses with which communication has been interrupted. In the second embodiment, the product number signals SN are transmitted from the information processing apparatuses in accordance with the request signals SR as a result of the third control described later being executed. After Step S71, the CPU 11 of the central ECU 10 causes the processing to proceed to Step S72.

In Step S72, the CPU 11 of the central ECU 10 starts to wait for the reception of the product number signal SN transmitted from each of the power train ECU 20, the brake ECU 30, and the advanced driving assistance ECU 40. After Step S72, the CPU 11 of the central ECU 10 causes the processing to proceed to Step S73.

In Step S73, the CPU 11 of the central ECU 10 determines whether the product number signals SN are received from the information processing apparatuses. Specifically, the CPU 11 of the central ECU 10 determines that the product number signals SN are received from the information processing apparatuses when the product number signals SN are received from all of the information processing apparatuses with which communication has been interrupted. When the CPU 11 of the central ECU 10 receives the product number signal SN, the CPU 11 of the central ECU 10 stores the product number signal SN in the storage 14 by linking the product number signal SN to the information processing apparatus that transmitted the product number signal SN.

When the CPU 11 of the central ECU 10 determines that the product number signals SN are not received from the information processing apparatuses in Step S73 (S73: NO), the CPU 11 of the central ECU 10 causes the processing to proceed to Step S71 again. Therefore, the CPU 11 of the central ECU 10 repeatedly executes the processing of Step S71 in a situation in which the product number signals SN have not been able to be received from the information processing apparatuses with which communication has been interrupted. As a result, the CPU 11 of the central ECU 10 transmits the request signals SR for requesting the transmission of the product number signals SN to the information processing apparatuses with which communication has been interrupted when the communication with the information processing apparatuses becomes possible after the communication with the information processing apparatuses is interrupted.

Meanwhile, when the CPU 11 of the central ECU 10 determines that the product number signals SN have been received from the information processing apparatuses in Step S73 (S73: YES), the CPU 11 of the central ECU 10 causes the processing to proceed to Step S28. The processing in Step S28 and thereafter in the second embodiment is similar to the processing in Step S28 and thereafter in the first embodiment.

### Third Control

Next, with reference to FIG. 6, the third control executed by each of the power train ECU 20, the brake ECU 30, and the advanced driving assistance ECU 40 is described. This third control is a control relating to the transmission of the product number signal SN in accordance with the request signal SR. The third control executed by the power train ECU 20 is described below. The CPU 21 of the power train ECU 20 executes the third control on the condition that the second control is executed, for example.

As shown in FIG. 6, the CPU 21 of the power train ECU 20 executes processing of Step S91 when the third control starts. In Step S91, the CPU 21 of the power train ECU 20 starts to wait for the reception of the request signal SR transmitted from the central ECU 10. After Step S91, the CPU 21 of the power train ECU 20 causes the processing to proceed to Step S92.

In Step S92, the CPU 21 of the power train ECU 20 determines whether the request signal SR has been received. When the CPU 21 of the power train ECU 20 determines that the request signal SR is not received in Step S92 (S92: NO), the CPU 21 of the power train ECU 20 causes the processing to proceed to Step S92 again. Meanwhile, when the CPU 21 of the power train ECU 20 determines that the request signal SR is received in Step S92 (S92: YES), the CPU 21 of the power train ECU 20 causes the processing to proceed to Step S93.

In Step S93, the CPU 21 of the power train ECU 20 transmits the product number signal SN to the central ECU 10. After Step S93, the CPU 21 of the power train ECU 20 causes the processing to proceed to Step S94.

In Step S94, the CPU 21 of the power train ECU 20 ends the waiting for the reception of the request signal SR transmitted from the central ECU 10. After Step S94, the CPU 21 of the power train ECU 20 ends the current third control.

### Effects of Present Embodiment

In the present embodiment, the following effects of (2-1) to (2-2) are exhibited in addition to the effects of (1-1) to (1-3).

(2-1) Instantaneous interruption of the electric power supply with respect to the power train ECU 20 and the like may have occurred when the communication between the CPU 11 of the central ECU 10 and the power train ECU 20 and the like is temporarily interrupted. The communication state may also be unstable when instantaneous interruption of the electric power supply with respect to the power train ECU 20 and the like occurs. As a result, even when the product number signals SN are transmitted from the power train ECU 20 and the like to the central ECU 10 in Step S52 of the second control, there is a fear that the central ECU 10 cannot receive the product number signals SN.

Regarding this point, the CPU 11 of the central ECU 10 transmits the request signals SR for requesting the transmission of the product number signals SN to the information processing apparatuses with which communication has been interrupted when the communication with the information processing apparatuses becomes possible after the communication with the information processing apparatuses is interrupted. As a result, even when a situation in which the communication is temporarily interrupted occurs, the product number signals SN are transmitted from the information processing apparatuses with which communication has been interrupted in a situation in which the communication becomes possibles. As a result, it becomes possible to more reliably receive the product number signals SN from the information processing apparatuses with the possibility of having the software activated due to the instantaneous interruption of the electric power supply.

(2-2) In the present embodiment, the CPU 11 of the central ECU 10 causes the processing to proceed to Step S72 on the condition that the request signals SR are transmitted in Step S71 in addition to the activation signals SA being transmitted in Step S11. Then, in Step S72, the CPU 11 of the central ECU 10 starts to wait for the reception of the product number signals SN transmitted from the power train ECU 20 and the like. As a result, the period of time that the waiting for the reception of the product number signals SN is executed becomes shorter as compared to a case in which the waiting for the reception of the product number signals SN is started immediately after the activation signals SA are transmitted, for example. As a result, it becomes possible to effectively reduce cases in which the processing load of the CPU 11 of the central ECU 10 increases due to the execution of the waiting for the reception of the product number signals SN.

### Modified Examples

The present embodiments can be carried out by being changed as below. The present embodiments and modified examples below can be carried out by being combined with each other as long as there are no technical contradictions.

The consistency check control may be changed in the first embodiment. For example, the method of confirming the agreement in Step S13 may be changed. As a specific example, the CPU 11 of the central ECU 10 may display options regarding whether to agree to the performance of the update of the software on a display of a personal terminal owned by the user of the vehicle 100 by outputting a control signal to the personal terminal. One example of the personal terminal is a so-called smartphone.

For example, the timing at which the waiting for the reception of the product number signal SN ends in Step S31 may be changed. As a specific example, in Step S22, the CPU 11 of the central ECU 10 may cause the processing to proceed to Step S31 when the CPU 11 of the central ECU 10 determines that the product number signals SN are received from all of the information processing apparatuses (S22: YES). In other words, the CPU 11 of the central ECU 10 may end the waiting for the reception of the product number signals SN in Step S31 when the product number signals SN are received from all of the information processing apparatuses. In this case, the CPU 11 of the central ECU 10 only needs to cause the processing to proceed to Step S23 after Step S31.

The first control may be changed in the first embodiment and the second embodiment.

For example, the processing of Step S41 may be omitted in the first control. In this case, each of the power train ECU 20, the brake ECU 30, and the advanced driving assistance ECU 40 may constantly execute the waiting for the reception of the activation signals SA regardless of the first control. In this configuration, the processing of Step S44 may be omitted in the first control.

The consistency check control may be changed in the second embodiment.

For example, the processing content in Step S61 may be changed. As a specific example, in Step S61, the CPU 11 of the central ECU 10 may determine whether the time elapsed from the time point of the processing of Step S71 last time is less than a defined period of time set in advance. In this case, the CPU 11 of the central ECU 10 causes the processing to proceed to Step S71 when the time elapsed from the time point of the processing of Step S71 last time is equal to or more than the defined period of time set in advance. In other words, the CPU 11 of the central ECU 10 may transmit the request signals SR in Step S71 for every defined period of time. At this time, it is preferred that the CPU 11 of the central ECU 10 transmit the request signals SR to all of the information processing apparatuses. As a result, the CPU 11 of the central ECU 10 may be able to execute the consistency check for every defined period of time.

The third control may be changed in the second embodiment.

For example, the processing of Step S91 may be omitted in the third control. In this case, each of the power train ECU 20, the brake ECU 30, and the advanced driving assistance ECU 40 may constantly execute the waiting for the reception of the request signal SR regardless of the third control. In this configuration, the processing of Step S94 may be omitted in the third control.

The configuration of the update system US may be changed in the first embodiment and the second embodiment.

For example, the update apparatus of the software is not limited to the central ECU 10. As a specific example, instead of the central ECU 10, the CPU 31 of the brake ECU 30 may execute the consistency check control by reading out the update program 12A stored in the ROM 32. In other words, the update apparatus of the software is not limited to the central ECU 10, and ECUs mounted on the vehicle 100 may be employed. Each of the number of processors and the number of memories mounted on the software update apparatus is not limited to one.

For example, the information processing apparatuses are not limited to the power train ECU 20, the brake ECU 30, and the advanced driving assistance ECU 40. As a specific example, the information processing apparatuses may be some of the power train ECU 20, the brake ECU 30, and the advanced driving assistance ECU 40. As a specific example, the information processing apparatuses may be other ECUs included in the vehicle 100. In other words, ECUs mounted on the vehicle 100 may be employed as the information processing apparatuses.

### Other Technical Ideas

Technical ideas that can be grasped from the embodiments and the modified examples are described.

An update apparatus of software according to a first aspect of the present disclosure, includes one or more processors configured to execute: transmitting an activation signal for instructing activation of software to an information processing apparatus mounted on a vehicle; starting to wait for reception of a product number signal indicating a product number of the software transmitted from the information processing apparatus on a condition that the activation signal is transmitted; and performing, on a condition that the product number signal is received, a consistency check of the software based on the received product number signal.

In the above aspect, the one or more processors may be configured to execute: storing the product number signal by linking the product number signal to the information processing apparatus that transmitted the product number signal when the product number signal is received; performing the consistency check of the software based on the received product number signal on a condition that the product number signal is received from each of all of the information processing apparatuses after a state of a system of the vehicle changes from an OFF state to an ON state while waiting for the reception of the product number signal; and performing the consistency check of the software based on the received product number signal and the stored product number signal on a condition that the product number signal is received from one or more of the information processing apparatuses until the state of the system of the vehicle changes from the OFF state to the ON state while waiting for the reception of the product number signal.

In the above aspect, the one or more processors may be configured to execute transmitting, when communication with the information processing apparatus becomes possible after the communication with the information processing apparatus is interrupted, a request signal for requesting transmission of the product number signal to the information processing apparatus with which the communication is interrupted.

In the above aspect, the one or more processors may be configured to execute ending the waiting for the reception of the product number signal on a condition that one or more of a first requirement and a second requirement are satisfied, the first requirement being a requirement that the product number signal from each of all of the information processing apparatuses is received, and the second requirement being a requirement that a determination is made that the software of the information processing apparatus is consistent by the consistency check.

An update method of software according to a second aspect of the present disclosure is executed by an update apparatus. The update method includes: transmitting an activation signal for instructing activation of software to an information processing apparatus mounted on a vehicle; starting to wait for reception of a product number signal indicating a product number of the software transmitted from the information processing apparatus on a condition that the activation signal is transmitted; and performing, on a condition that the product number signal is received, a consistency check of the software based on the received product number signal.

A non-transitory storage medium according to a third aspect of the present disclosure stores instructions that are executable by one or more processors of an update apparatus and that cause the one or more processors to perform the update method of software according to the second aspect.

An update system of software according to a fourth aspect of the present disclosure, includes: an update apparatus mounted on a vehicle, and an information processing apparatus mounted on the vehicle. The update apparatus is configured to execute: transmitting an activation signal for instructing activation of software to an information processing apparatus mounted on the vehicle; starting to wait for reception of a product number signal indicating a product number of the software transmitted from the information processing apparatus on a condition that the activation signal is transmitted; and performing, on a condition that the product number signal is received, a consistency check of the software based on the received product number signal. The information processing apparatus is configured to execute: performing the activation of the software at a timing when a state of the information processing apparatus changes from an OFF state to an ON state on a condition that the activation signal is received; and transmitting the product number signal to the update apparatus on a condition that the activation is performed.

What is claimed is:

1. An update apparatus of software, comprising one or more processors configured to execute:
transmitting an activation signal for instructing activation of software to an information processing apparatus mounted on a vehicle;
starting to wait for reception of a product number signal indicating a product number of the software transmitted from the information processing apparatus on a condition that the activation signal is transmitted; and
performing, on a condition that the product number signal is received, a consistency check of the software based on the received product number signal.

2. The update apparatus of software according to claim 1, wherein the one or more processors is configured to execute:
storing the product number signal by linking the product number signal to the information processing apparatus that transmitted the product number signal when the product number signal is received;
performing the consistency check of the software based on the received product number signal on a condition that the product number signal is received from each of all of the information processing apparatuses after a state of a system of the vehicle changes from an OFF state to an ON state while waiting for the reception of the product number signal; and
performing the consistency check of the software based on the received product number signal and the stored product number signal on a condition that the product number signal is received from one or more of the information processing apparatuses until the state of the system of the vehicle changes from the OFF state to the ON state while waiting for the reception of the product number signal.

3. The update apparatus of software according to claim 1, wherein the one or more processors is configured to execute transmitting, when communication with the information processing apparatus becomes possible after the communication with the information processing apparatus is interrupted, a request signal for requesting transmission of the product number signal to the information processing apparatus with which the communication is interrupted.

4. The update apparatus of software according to claim 1, wherein the one or more processors is configured to execute ending the waiting for the reception of the product number signal on a condition that one or more of a first requirement and a second requirement are satisfied, the first requirement being a requirement that the product number signal from each of all of the information processing apparatuses is received, and the second requirement being a requirement that a determination is made that the software of the information processing apparatus is consistent by the consistency check.

5. An update method of software executed by an update apparatus, the update method comprising:
transmitting an activation signal for instructing activation of software to an information processing apparatus mounted on a vehicle;
starting to wait for reception of a product number signal indicating a product number of the software transmitted from the information processing apparatus on a condition that the activation signal is transmitted; and
performing, on a condition that the product number signal is received, a consistency check of the software based on the received product number signal.

6. A non-transitory storage medium storing instructions that are executable by one or more processors of an update apparatus and that cause the one or more processors to perform the update method of software according to claim 5.

7. An update system of software, comprising:
an update apparatus mounted on a vehicle, the update apparatus being configured to execute:
transmitting an activation signal for instructing activation of software to an information processing apparatus mounted on the vehicle;
starting to wait for reception of a product number signal indicating a product number of the software transmitted from the information processing apparatus on a condition that the activation signal is transmitted; and
performing, on a condition that the product number signal is received, a consistency check of the software based on the received product number signal; and
the information processing apparatus, the information processing apparatus being configured to execute:
performing the activation of the software at a timing when a state of the information processing apparatus changes from an OFF state to an ON state on a condition that the activation signal is received; and
transmitting the product number signal to the update apparatus on a condition that the activation is performed.
